(19) United States
(12) Patent Application Publication
(10) Pub. No.: US 2026/0365410 A1
(43) Pub. Date: Nov. 19, 2026

(54) RV SEWER HOSE SUPPORT BOX WITH HOSE STORAGE

(71) Applicant: CAMCO MANUFACTURING, LLC, Greensboro, NC (US)

(72) Inventors: Brandon Blakely, Burlington, NC (US); Blake Lamb, Greensboro, NC (US); Niko Jovicevic, Statesville, NC (US)

(21) Appl. No.: 19/209,547

(22) Filed: May 15, 2025

(51) Int. Cl. B65D 81/36; B60R 15/00; B65D 1/26; B65D 25/28; B65D 51/24

(52) U.S. Cl. CPC B65D 81/361; B65D 1/26; B65D 25/2897; B65D 51/24; B60R 15/00

(57) ABSTRACT

An RV sewer hose support apparatus with sewer hose storage including an integrated system combining storage and support functions for a sewer hose and a plurality of support bridges. The apparatus including a box with a locking lid, wherein the lid further including raised corners with indentations for stacking, molded handles for transport, and integrated trough to position a hose thereon. The box and lid are secured together via a locking tab, which protects its contents and maintains hygienic separation between the sewer hose, support bridges, and its surroundings. The plurality of support bridges, when placed in combination with the box and lid, provide a continuous downward pitch for more efficient gravity-driven drainage, and when stored, nest within the box. Each support bridge includes a support trough and set of legs, which vary in heigh to provide the continuous downward pitch when placed in a row.

### TECHNICAL FIELD

The present disclosure relates generally to recreational vehicle (RV) sewer hose storage and management. In particular, some aspects of the disclosure may relate to systems and apparatuses for storing sewer hoses in a sewer hose support and storage box.

### DESCRIPTION OF RELATED ART

Sewer hoses are important for RV sanitation, enabling the safe and efficient disposal of blackwater or waste. Various storage solutions may be used to keep sewer hoses secure, clean, and easily accessible. Traditional methods often involve manually placing hoses in the bumper or an external storage compartment on the RV, which can be cumbersome and expose the sewer hoses to environmental damage. Specialized storage boxes may improve user convenience and extend the lifespan of the sewer hoses by providing dedicated, protective spaces.

In the disposal context, sewer hoses are more generally used for connecting the RV's waste outlet to a dump station, which often will facilitate the disposal of both blackwater and greywater. Typically, this process involves attaching one end of the sewer hose to the RV's waste vale and the other end to the dump station's inlet. For improved disposal performance, a hose may be placed downhill from the RV to the dump station. This downhill alignment may promote gravity-assisted flow, which can help efficiently move waste through the hose without blockages. The downward slope may prevent stagnant waste from building up, and may further reduce the risk of clogs. Additionally, support systems may sometimes be used to elevate the sewer hose, helping avoid contact between the sewer hose and undesirable terrain.

### BRIEF SUMMARY OF THE DISCLOSURE

Embodiments of the present disclosure may include a sewer hose storage apparatus. The sewer hose storage apparatus may include a box (generally squared, rectangular or otherwise) with a base and sidewalls that define an interior space. The box may be complemented by a lid releasably attachable to the box that may enclose the interior space. The lid may be hinged and may be secured to the box with one or more locking tabs. The box may be lifted with a molded handle or handles formed into the sidewall (or sidewalls) of the box. Other implementations may include one or more flip-down handles affixed to the lid. The box may further include a first trough integrated into the base of the box and a second trough integrated into the lid. The first and second troughs may each be of a geometry to support a sewer hose in a predetermined position.

According to further embodiments of the present disclosure the lid may include four raised corners, wherein each raised corner may further include an indentation. The apparatus may be used in combination with a support bridge system, wherein the support bridge system may include a plurality of support bridges, wherein each support bridge may be a different height such that when the plurality of support bridges are disposed in a particular order, e.g., a row, the different heights of each support bridge may define a continuous downward pitch. Each support bridge may further include a support trough. Further embodiments may include wherein the locking tab includes a top portion and a bottom portion, wherein the top portion may be integrated into the lid and the bottom portion may be integrated into the handle. Additionally, the sidewalls of the apparatus may include two short sidewalls and two long sidewalls, wherein the handle may be integrated into at least one of the short sidewalls.

Embodiments of the present disclosure may include a system for storing a sewer hose and support bridges. The system may include a box with a base and sidewalls that define an interior space. The box may be complemented by a lid that may be attachable to the box and encloses the interior space. The system may include a first support bridge of a geometry to be nested within the box, and a trough integrated into the box of a geometry to support the support bridge when nested within the box.

Further embodiments of the present disclosure may include a handle integrated into the box. The system may also include wherein the lid includes four raised corners, wherein each raised corner includes an indentation for stacking multiple boxes. The system may include a second support bridge, wherein the second support bridge may be a different height from the first support bridge, such that when the first and second support bridges are placed in a row, the first and second support bridge may define a continuous downward pitch. Further, the system may include a third support bridge, wherein the third support bridge may be a different height from the first and second support bridges, such that when the first, second, and third support bridges are placed in a row, the first, second, and third support bridges may define the continuous downward pitch. Each of the support bridges may further include a support trough, which may be similar to the second trough that may be integrated into the lid.

Embodiments of the present disclosure may further include a sewer hose support system. The sewer hose support system may include a box with a base and sidewalls defining an interior space, wherein the sidewalls further include two short sidewalls and two long sidewalls. The system may include a lid of a complementary geometry to the box such that the lid covers the interior space. A locking tab integrated into the box and the lid may secure the lid to the box when attached to the box. The system may be transportable via a pair of molded handles positioned on each short sidewall of the box, wherein each short sidewall of the box is laterally opposite from each other. Additionally, a first trough may be integrated into the lid and a second trough may be integrated into the box, the first and second trough may be adapted to cooperate with a support bridge system to retain a sewer hose.

Further embodiments of the present disclosure may include wherein the support bridge system may include a plurality of support bridges, wherein each support bridge of the plurality of support bridges may include a support trough that nests with the second trough when stored, and wherein each support bridge of the plurality of support bridges may be a different height defining a continuous downward pitch when placed in a row. Each support bridge may further include a set of four legs. Further embodiments may include wherein each molded handle of the pair of molded handles may include a locking tab, and wherein the lid may further include four raised corners, wherein each raised corner may further include an indentation.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are solely defined by the claims attached hereto and their equivalents thereof.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 depicts a diagram of a perspective view of an example sewer hose storage apparatus, in accordance with various embodiments of the present disclosure.

FIG. 2 depicts a diagram of a perspective view of an example sewer hose storage lid, in accordance with various embodiments of the present disclosure.

FIG. 3 depicts a diagram of a perspective view of an example sewer hose storage box, in accordance with various embodiments of the present disclosure.

FIG. 4 depicts a diagram of a lowered perspective view of an example sewer hose storage box, in accordance with various embodiments of the present disclosure.

FIG. 5 depicts a diagram of a skeleton perspective view of an example locking tab, in accordance with various embodiments of the present disclosure.

FIG. 6 depicts a diagram of a perspective view of two example sewer hose storage apparatuses in a stacked configuration, in accordance with various embodiments of the present disclosure.

FIG. 7 depicts a diagram of a perspective view of an example support bridge, in accordance with various embodiments of the present disclosure.

FIG. 8 depicts a diagram of a front plan view of an example support bridge system in a nested configuration, in accordance with various embodiments of the present disclosure.

FIG. 9 depicts a diagram of a top-down perspective view of an example support bridge system in a nested configuration that is stored in a sewer hose storage box, in accordance with various embodiments of the present disclosure.

FIGS. 10A & 10B depict diagrams of a perspective view and a side plan view, respectively, of an example sewer hose support system, in accordance with various embodiments of the present disclosure.

The figures are not exhaustive and do not limit the present disclosure to the precise form disclosed.

### DETAILED DESCRIPTION

Embodiments of the sewer hose storage apparatus may improve upon conventional systems and advance RV sanitation technology by integrating storage and support functions into a single apparatus. Embodiments disclosed herein may offer several features that enhance the convenience and hygiene of storing and managing sewer hoses in RV, providing a more comprehensive solution for waste disposal and sewer hose storage.

The sewer hose storage apparatus may include a box designed to house both a sewer hose and a support bridge system. The sewer hose is one example only, and the storage apparatus may be used to store other types of hoses used both in combination with RVs and hoses used for other industries or applications. In one embodiment, the box is dimensioned to accommodate a sewer hose 20 feet in length, but other box dimensions can be implemented for other length and diameter hoses.

The box may include a base and four sidewalls that define an interior space. Of the four sidewalls, two opposing sidewalls may be short sidewalls and two opposing sidewalls may be long sidewalls, with long and short made in relation to each other to thereby form a generally rectangular shape. Further embodiments of the box may include greater or fewer sidewalls, or may include different configurations of sidewalls, for example, the box may be constructed as a square, including four sidewalls of approximately equal proportions. Furthermore, the box may be constructed from durable plastics, such as polyethylene or polypropylene, metals, such as aluminum, or composite materials often found in outdoor recreation equipment and accessories.

The sewer hose storage apparatus may further include a lid designed to engage with the box, which may enclose the interior space. The lid may include raised corners and indentations that allow for stacking multiple boxes, which may improve storage space optimization when several units are used. Some embodiments, for example, may include four raised corners, each with an indentation disposed thereon. Further embodiments of the lid may include greater or fewer raised corners, may include greater or fewer indentations on each corner, may include raised corners without indentations, or may not include raised corners at all.

The sewer hose storage apparatus may include one or more locking tabs integrated into the lid and box to secure the lid to the box. Some embodiments of the locking tab may include a top portion integrated into the lid and bottom portion integrated into the box or the handle, where the top and bottom portion are complementarily engageable. The top portion of the locking tab and the lower portion of the locking tab may interface mechanically, as discussed in relation to FIG. 5. The locking tab may improve the sewer hose storage apparatus maneuverability, ensuring that the lid does not separate from the box during transport. Alternatively, the locking tab may be constructed using a magnetic closure, snap-fit design, button or snap clasp, a spring latch, a toggle latch, a hook-and-eye clasp, or other repeatably securable mechanisms.

The sewer hose storage apparatus may further include molded handles incorporated into the box's structure, which may improve transportation of the apparatus and general handling thereof. The molded handles may be positioned on opposing sidewalls such that a user may carry the sewer hose storage apparatus by lifting opposing sides of the box via the molded handles. The molded handles may be integrated into the short sidewalls of the box or the long sidewalls of the box. Additionally, in embodiments with more than two handles, the handles may be integrated into both the short and long sidewalls of the box. The molded handles may further include a textured grip, which may be constructed from applied textured material, such as spray or protrusions. Other embodiments may include a single handle on the top of the lid, typically centered, to allow for balanced lifting. This handle may be made of metal, leather, wood, plastics, or fabric and fastened with small screws, rivets, welds, adhesives or other attachment mechanisms. Alternatively, two side handles mounted on opposite vertical sides of the box near the top edge, allowing for two-handed carrying or assistance from another person. The side handles might be fixed (rigidly attached) or swinging (hinged) to fold flat when not in use, minimizing bulk.

The sewer hose storage apparatus may include a first trough and a second trough. The first trough may be integrated into the base of the box, such that when the box is turned upside down (e.g., when an opening to the interior space is pointed towards the ground and the base is pointed towards the sky) the first trough may allow a portion of sewer hose to be disposed thereon. Similarly, the second trough may be integrated into the lid. The second trough may be used in combination with the first trough to create a downward sloping channel so that liquid in the hose may drain through. Embodiments of the present disclosure that include a multi-element support bridge system may have the box and lid placed as the first and last support trough in the system.

The sewer hose storage apparatus may be designed to store a plurality of support bridges, which may each be dimensioned to maintain a continuous downward pitch when placed in a row. In other words, each support bridge of the plurality of support bridges may be a different height, such that the support bridges can be nested when stacked (e.g., to store the support bridges in the sewer hose storage apparatus) and to slope a hose disposed thereon downward to improve gravity-driven drainage through the hose. Each support bridge of the plurality of support bridges may include a support trough and four legs. Each of the four legs may be placed at a corner of the support trough. Each set of four legs on each support bridge may be a similar height, however, each set of legs on different support bridges may be a different height. Further embodiments of the support bridges may include more or less legs.

The integration of the plurality of support bridges within the sewer hose storage apparatus may allow for more compact and efficient storage during transport. Each support bridge may nest within the box's interior space, with each support trough nesting with each other's support trough and a top support bridge nesting with the first trough of the box. This design may simplify organization and minimize space requirements, while maintaining sufficient numbers of support bridges to place a sewer hose in a continuous downward pitch over a desired distance.

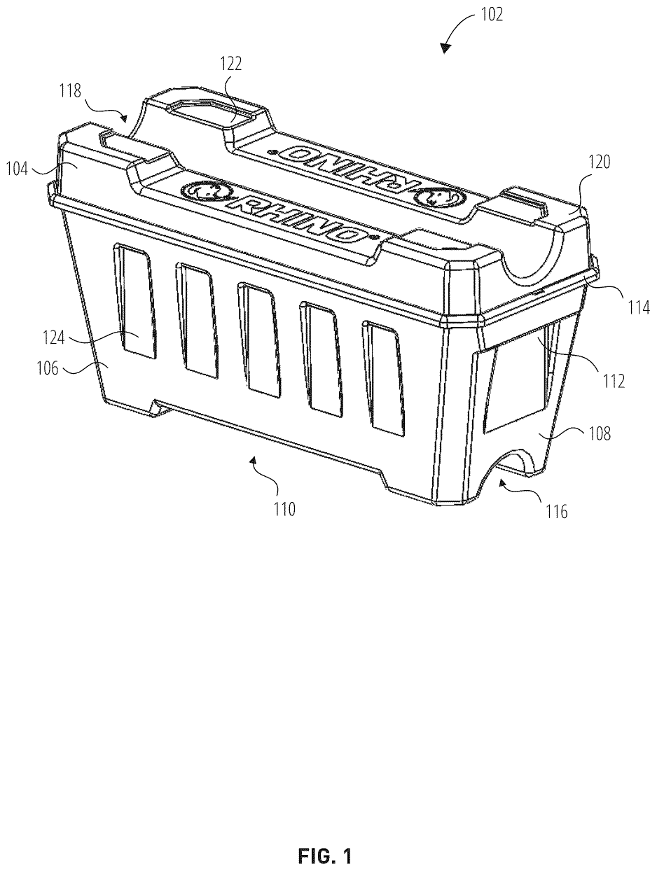

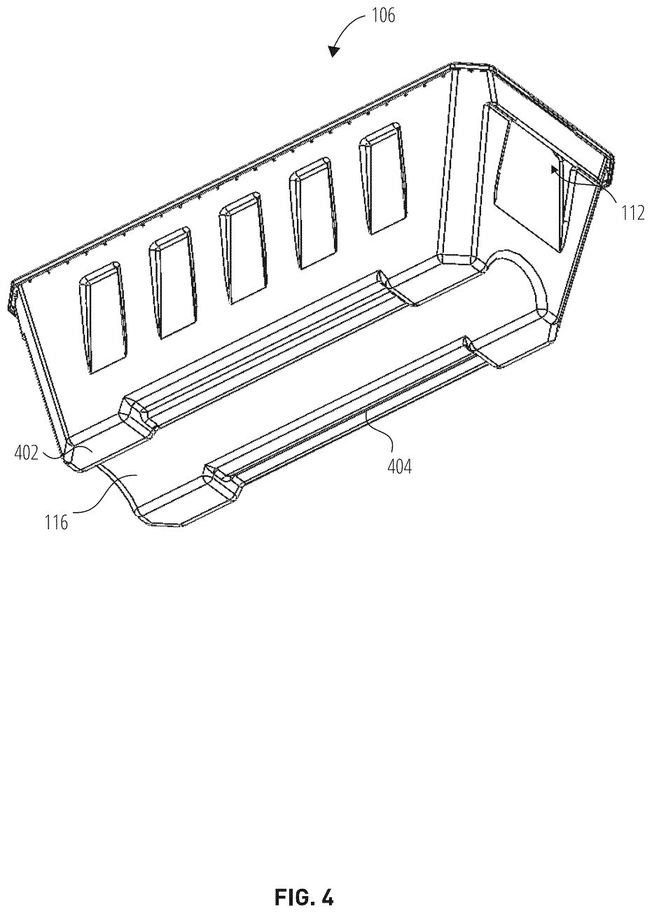

With respect to the figures, FIG. 1 is a diagram depicting a perspective view of an example sewer hose storage apparatus 102, in accordance with various embodiments of the disclosed technology. The sewer hose storage apparatus 102 may include a box 106 and a lid 104. The box 106 may be designed to provide secure storage for a sewer hose and support bridge system. The box's 106 structure may include four sidewalls 108 and a base 110, which together define an interior space (as depicted, e.g., in relation to FIG. 3) for housing the sewer hose and support bridge system. The box 106 may include two types of sidewalls 108. The sidewalls 108 may include two long walls and two short walls, creating a rectangular shape that improves efficient stacking and storage. As discussed, further embodiments may include more or less of a particular type of sidewall or may only include a single type of sidewall in a square-body configuration.

The short sidewalls of the box 106 may include integrated handles 112, which may be cut or integrated into the walls to allow for easier transportation. The handles 112 may be positioned on opposing short sidewalls to balance the weight of the box when lifted. Above each handle 112, may be a locking tab 114, which may secure the lid 104 to the box 106, ensuring that the contents remain enclosed and protected during transport and storage.

Adjacent to the sidewalls 108 may be a base 110. The base 110 of the box 106 may include a trough 116, disposed along the length of the box 106. The trough 116 may be an approximately half-circle depression into the base 110 of the box 106, designed to support a portion of the sewer hose when the box is inverted. This integrated trough 116 may improve positioning of the hose, enhancing stability and placement during use. The trough 116 may further be described with reference to a first trough throughout the present disclosure. Similarly, the lid 104 may incorporate a second trough 118 depressed into its structure, which may mirror the design of the base's trough 116. The second trough 118 may assist in supporting the sewer hose when the lid 104 is used as a part of the sewer hose support system.

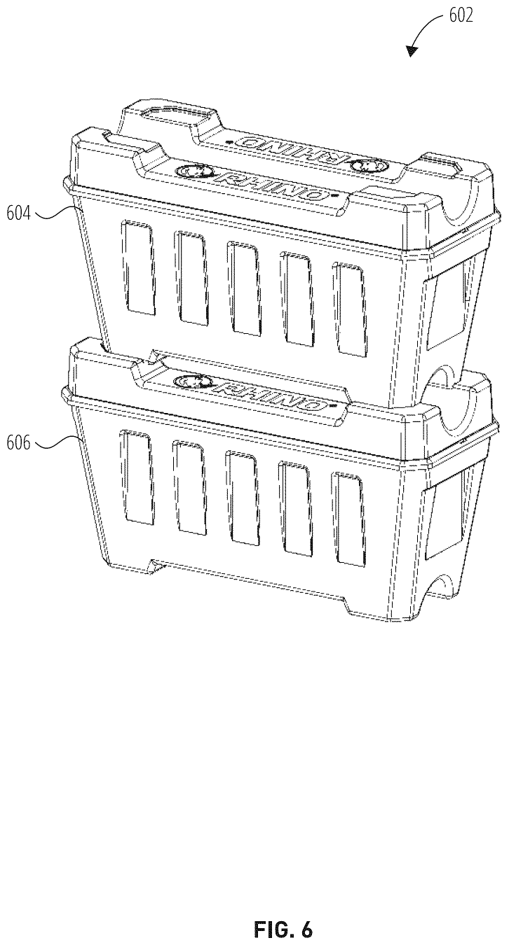

The lid 104 of the sewer hose storage apparatus 102 may include raised corners 120, which may be included to facilitate stacking. Some embodiments of the lid, for example, may include four raised corners 120, with each raised corner 120 disposed approximately above each intersection of long and short sidewalls 108. Each raised corner 120 may include indentations 122, which may be depressions formed into a portion of the raised corner's top surface. The indentations may further facilitate stacking, allowing a second box to be securely stacked on top of the first box (e.g., as depicted in FIG. 6). These indentations 122 may help align the boxes during stacking, ensuring boxes do not slide in relation to each other during transport.

The long sidewalls of the box 106 may include sidewall moldings 124, which may be indentations molded or depressed into the long sidewalls. These sidewall moldings 124 may provide additional structural support and can assist in lifting the box.

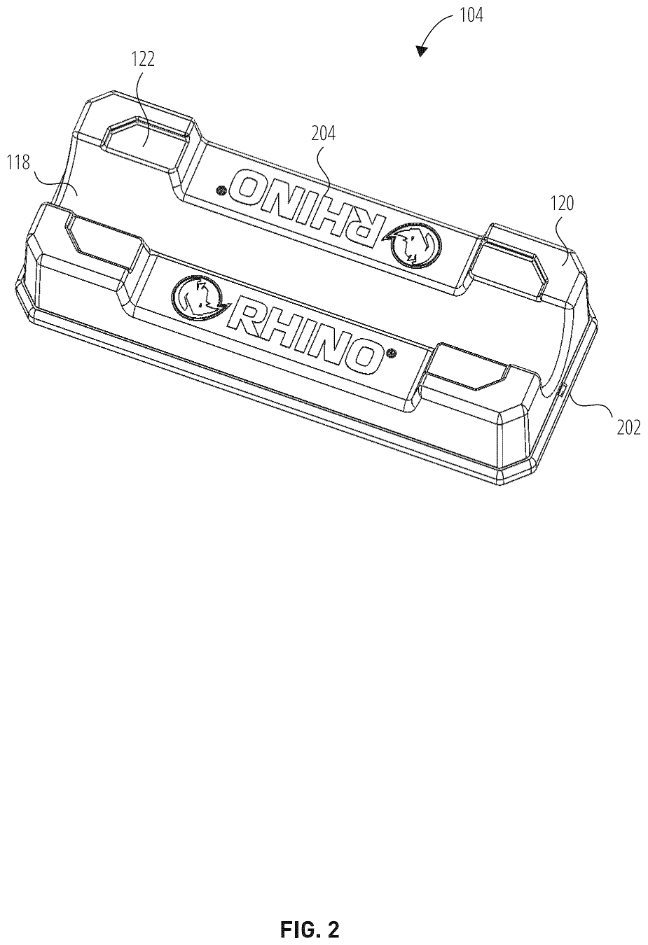

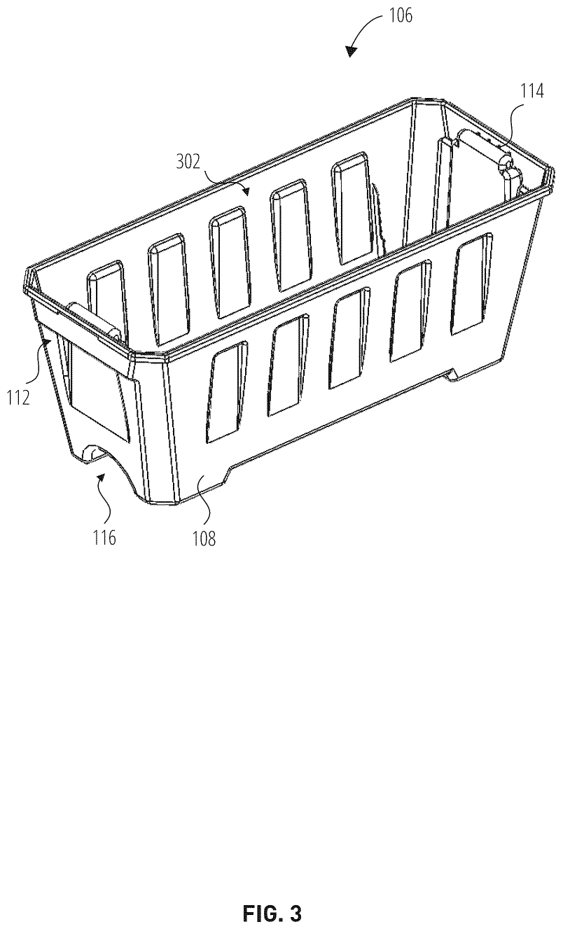

FIG. 2 is a diagram depicting a perspective view of an example sewer hose storage lid 104, in accordance with various embodiments of the disclosed technology. The lid 104 may be designed to cover and secure to the box 106, which may enhance the sewer hose storage apparatus's ability to keep the stored contents enclosed. As discussed, the lid 104 may include the second trough 118, which may be integrated, molded, or depressed into its structure. This second trough 118, shaped approximately as a half circle, may be placed to support a portion of the sewer hose when the lid 104 is used as part of the hose support system. The second trough 118 may extend, laterally, across the length of the lid 104. In further embodiments, the second trough may extend a portion or partially across the lid or may extend across the width of the lid.

The lid 104 may include the raised corners 120, which may be disposed on either side of the second trough 118. The raised corners 120 may provide additional strength and stability to the lid 104, particularly when supporting its ability to bear weight from stacked boxes. Each raised corner 120 may include an indentation 122. The indentations 122 may further facilitate the secure stacking of additional boxes on top of the first box. The indentations 122 may improve alignment and stability when boxes are stacked, optimizing storage space and preventing slippage during transport or storage.

Further, the lid 104 may include a top portion of the locking tab 202, which may engage with a bottom portion of the locking tab located on the box 106. The top portion of the locking tab 202 may secure the lid 104 to the box, maintaining the integrity of the storage system and preventing accidental opening. The locking tab may be designed for ease of use, allowing quick and secure attachment and detachment of the lid.

The structure of the lid 104 may also include a lowered lateral center area 204, which may be disposed between the raised corners on the longer sidewall edge. This lowered lateral center area 204 may aid in the stacking process by providing a recess that accommodates a user's hand to grip beneath the base when stacking or unstacking boxes.

FIG. 3 is a diagram depicting a perspective view of an example sewer hose storage box 106, in accordance with various embodiments of the disclosed technology. The box 106 may be designed to house the sewer hose and support bridges. As discussed, the box 106 may include various sidewalls, e.g., four sidewalls 108, which may define its shape and contribute to the overall structure. The sidewalls 108 may be integral to forming the interior space 302, where the hose and support bridges may be stored. The interior space 302 may include a back side of the trough (not shown), which may be approximately a half-circle indentation into the interior space. The back side of the trough may interface with the support troughs on the support bridges when stored within the box.

The sidewalls 108 may include integrated handles 112, positioned on the short sidewalls. The handles 112 may be molded into the box's 106 structure. Above each handle 112, may be a locking tab 114. The locking tab 114 may complement the top portion of the locking tab on the lid to secure the lid to the box.

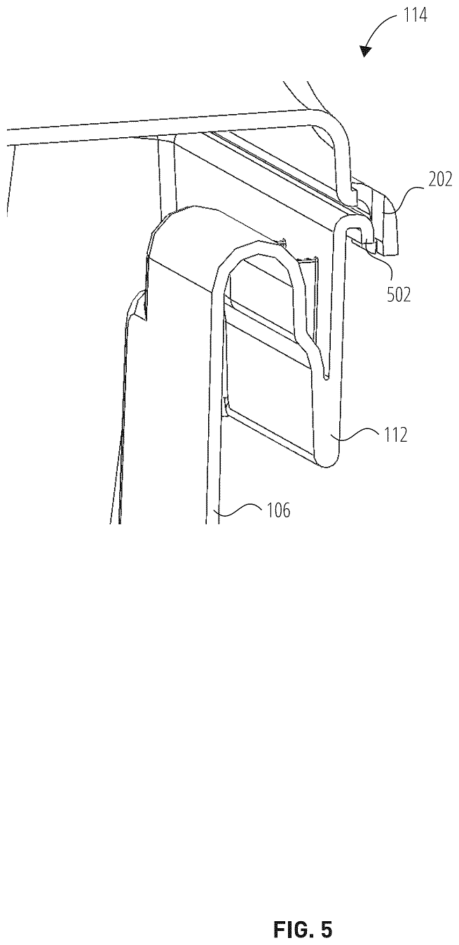

FIG. 4 is a diagram depicting a lowered perspective view of an example sewer hose storage box 106, in accordance with various embodiments of the disclosed technology. The box 106 may include handles 112, which may be cut or depressed upward into the short sidewalls at a portion of the short sidewalls closer to the where the lid connects to the box. The upward design may facilitate improved gripping and lifting, accommodating user needs for transport and handling.

The trough 116 may be more clearly depicted in FIG. 4. As shown, the trough 116 may be integrated into the base of the box 106. The trough 116, shaped as a half-circle, may similarly support and/or stabilize a portion of the sewer hose during use. Such use may include inverting the box 106 and placing a portion of the sewer hose thereon.

The base of the box may further include base protrusions 402, which may be lowered corners designed to interface with the indentations on the raised corners of the lid. The base protrusions 402 may improve the stacking of multiple boxes, providing stability and preventing slippage during storage or transport. The interaction between the base protrusions 402 and lid indentations may support efficient and safe stacking.

Additionally, the box may include a raised base 404, which may consist of raised lateral portions similar to the lowered center portion of the lid. The raised base 404 may complement the structure of the lid, providing additional space for a user to grip beneath the box when multiple boxes are in a stacked configuration or to grip the box when lifting a single box from the ground.

FIG. 5 is a diagram depicting a skeleton perspective view of an example locking tab 114, in accordance with various embodiments of the disclosed technology. The locking tab 114 may be designed with both a top portion 202 and a lower portion 502, which may interface together to provide a secure locking mechanism.

The top portion of the locking tab 202 may include a protrusion that is engineered to snap around the lower portion 502. This snapping action may provide a connection between the two portions, preventing accidental disengagement and ensuring the contents of the box remain enclosed. The interface between the top and lower portions may be designed to engage when the lid is pressed onto the box and disengage when the lid is pulled from the box.

The lower portion of the locking tab 502 may extend upward from an exterior surface of the handle 112. This placement may be opposite to the portion of the handle engaged by the user's fingers.

FIG. 6 is a diagram depicting a perspective view of two example sewer hose storage boxes in a stacked configuration, in accordance with various embodiments of the present disclosure. As depicted, FIG. 6 may illustrate a configuration of stacked sewer hose storage boxes 602, which may include a first sewer hose storage box 604 positioned above, or disposed on top of, a second sewer hose storage box 606. This stacking configuration may demonstrate the more efficient use of space enabled by the components of the boxes, such as the raised corners and indentations. While FIG. 6 depicts two boxes, this configuration can accommodate more or fewer boxes depending on the user's needs and available storage space. The stacking capability may enhance the practicality of the storage system, allowing RV users to maximize their storage efficiency by securely stacking multiple units.

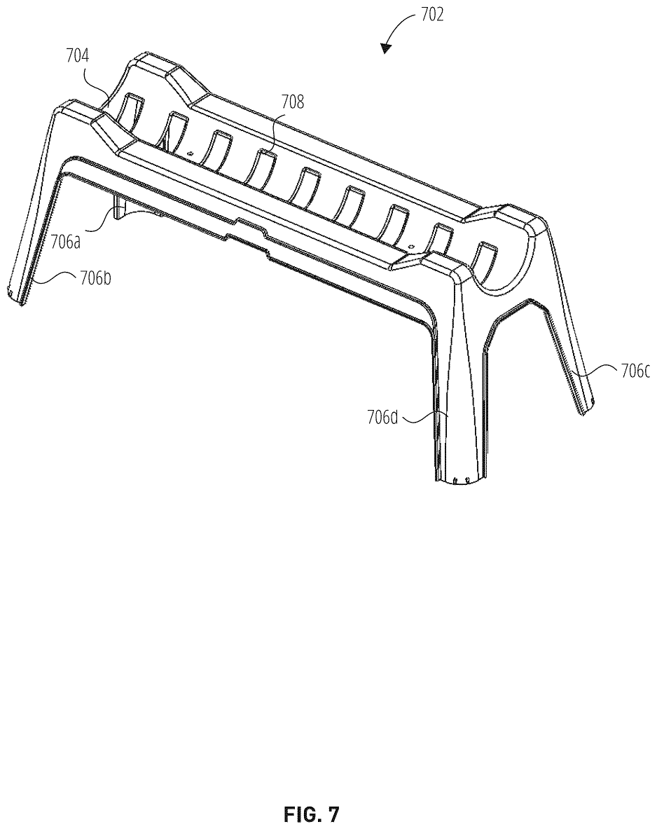

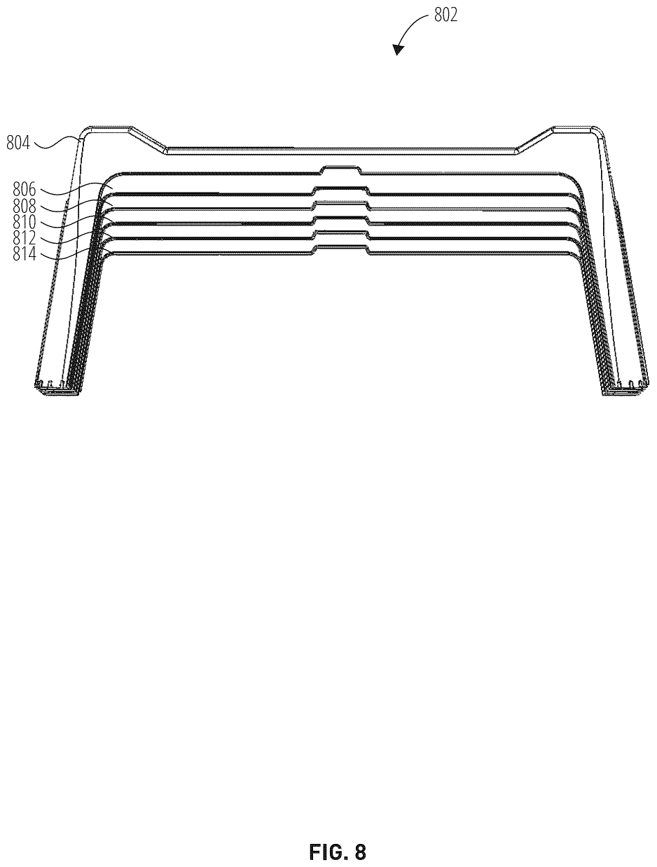

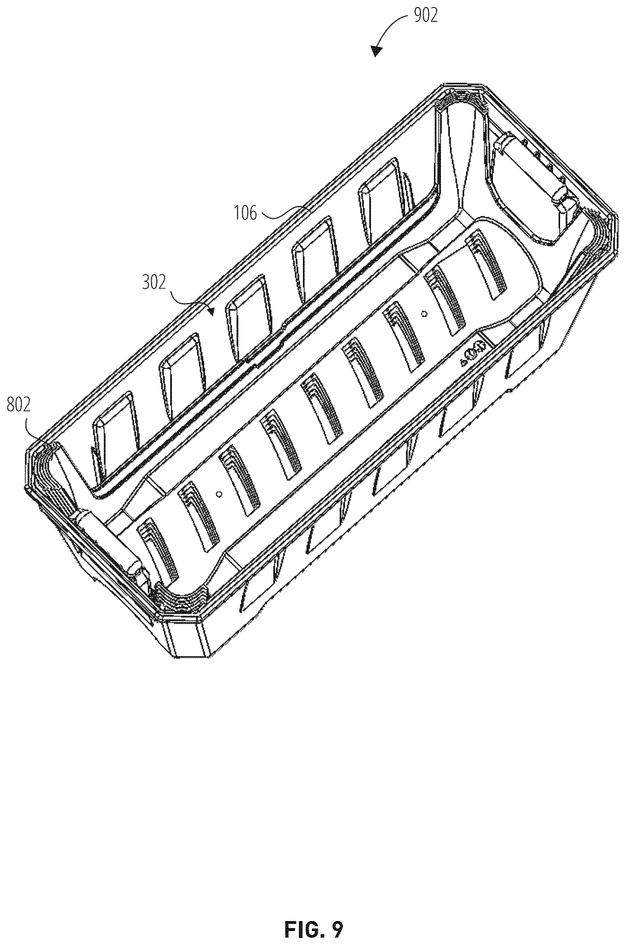

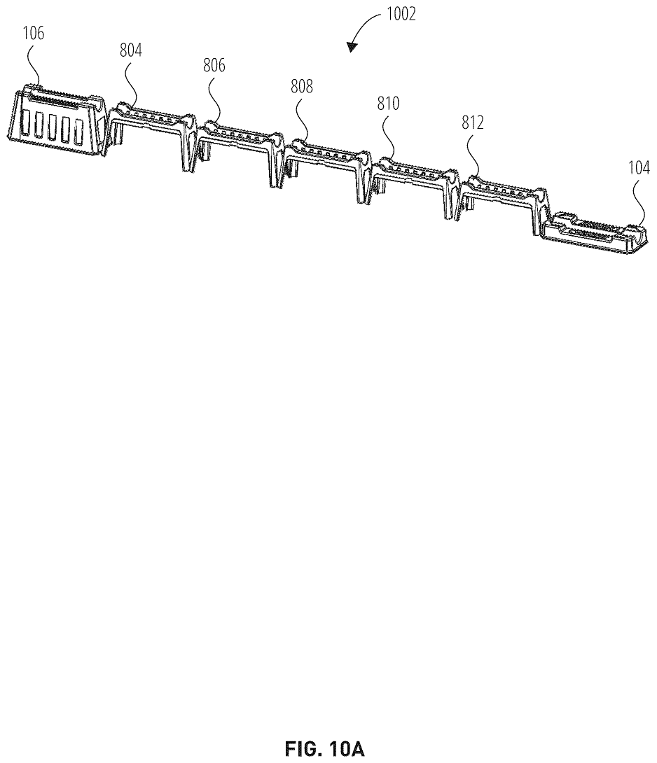

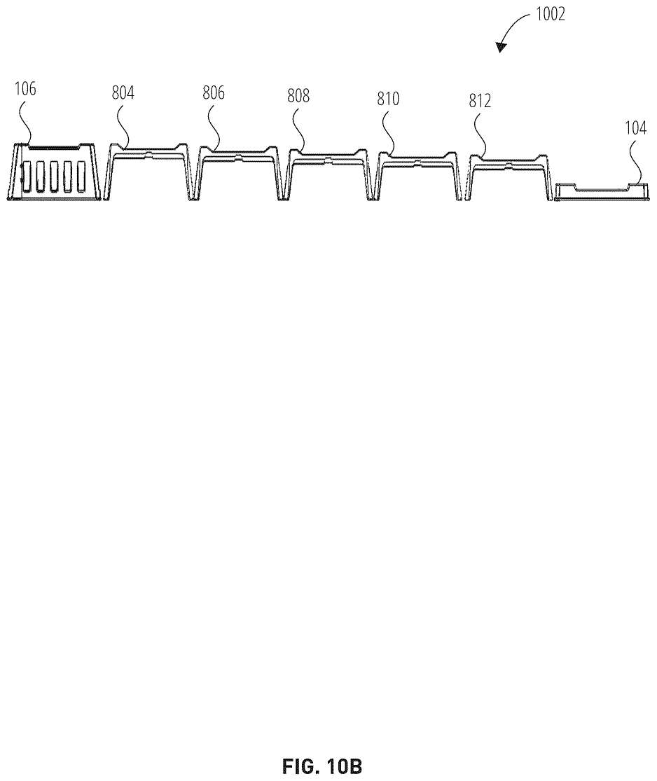

FIG. 7 is a diagram depicting a perspective view of an example support bridge 702, in accordance with various embodiments of the present disclosure. The support bridge 702 may facilitate gravity-driven drainage between an RV outlet and a dump station. Embodiments of the disclosed system may include multiple support bridges 702, for example, as depicted in FIGS. 8, 10A, and 10B. Each support bridge 702 may include a support trough 704, which may be disposed laterally through the center of the support bridge 702. The support trough 704 may be configured to support a portion of the sewer hose, maintaining its alignment and stability during use.

Each support bridge 702 may include a set of legs, which may range in number from two to eight. For example, as depicted in FIG. 7, the support bridge 702 may include four legs 706a-706d. The legs may be positioned at the corners of the support bridge 702 to provide support and stability when the support bridge 702 is disposed on a ground surface, such as a campsite. The legs may maintain the support bridge's position such that the support trough 704 remains level or pitched when in place. The leveled or pitched configuration may facilitate the downward pitch for efficient drainage when placed in combination with additional support bridges. The legs may extend from the corners at varying distances. For example, a first support bridge may include legs that are approximately three inches long, whereas a second support bridge may include legs that are approximately two and a half inches long. Embodiments of the support bridge with four legs, may include a first leg 706a, a second leg 706b, a third leg 706c, and a fourth leg 706d. Additional embodiments may include more or less legs.

The support trough 704 may include a support trough opening 708. The support trough opening 708 may be a series of slits located through the bottom of the support trough. The openings may allow water or disposal fluids to pass through the support trough without significant pooling, preventing the accumulation of liquid within the trough and ensuring that the sewer hose remains dry and functional.

When used in combination with the inverted box and lid placed at opposing ends, multiple support bridges may create a continuous, gravity-driven slope. This configuration may allow for optimal flow of waste through the sewer hose, reducing the likelihood of blockages and ensuring smooth operation. Each support bridge may be of a slightly different height, contributing to the continuous downward pitch necessary for effective drainage.

FIG. 8 is a diagram depicting a front plan view of an example plurality of support bridges 802 in a nested configuration, in accordance with various embodiments of the present disclosure. As depicted, various numbers of support bridges may be stacked on nested with each other to provide for more efficient storage of multiple support bridges. As shown in FIG. 8, six support bridges may be stored in a nested configuration. In such a configuration, a first support bridge 804 may be stacked on a second support bridge 806, which may further be stacked on a third support bridge 808, which may further be stacked on a fourth support bridge 810, which may further be stacked on a fifth support bridge 812, which may even further be stacked on a sixth support bridge 814. The design of the support bridges may allow each support trough of each support bridge to nest with those directly above or below it.

Furthermore, the nesting configuration may be achieved through alignment of the legs of each support bridge, such that the legs of each support bridge may be designed to cover the legs of the shorter support bridge beneath them. This alignment may include the legs approximately matching up at an end of each leg, despite each set of legs on each support bridge being of a different length. Such a configuration allows for conservation of space and further facilitations the structure for the support bridges to form a downward pitch when deployed.

FIG. 9 is a diagram depicting a top-down perspective view of an example plurality of support bridges 802 in a nested configuration that are stored in a sewer hose storage box 106, in accordance with various embodiments of the present disclosure. As depicted, the plurality of support bridges nested in the sewer hose storage box 902 may include the plurality of support bridges 802 (as depicted in FIG. 8) in an inverted configuration and arranged to fit within the interior space 302 of the box 106. The design may allow for use of the box's interior space 302, while leaving sufficient space for a sewer hose to further be stored on top of the plurality of support bridges 802, yet still within the confines of the interior space 302.

FIGS. 10A & 10B are diagrams depicting a perspective view and a side plane view, respectively, of an example sewer hose support kit 1002, in accordance with various embodiments of the present disclosure. The example sewer hose support kit 1002 may include an inverted box 106, which may serve as one end of the end supports for the hose, multiple support bridges 804-812, and a lid 104. The first through fifth support bridges 804-812, may be placed between the inverted box 106 and the lid 104, such that the inverted box 106 and lid 104 are placed on the ends of the sewer hose support kit 1002. Each support bridge may be a different height (by differing the length of the sets of legs), which may facilitate the gravity-driven downward pitch for more optimal drainage. This configuration may place the sewer hose in a continuous slope for more efficient drainage. The lid 104, which may be positioned at the far end of the sewer hose support kit 1002, may act as the terminal support for the sewer hose before disposing in the dump station.

While the storage apparatus is described herein in detail with reference to its use in connection with sewer hoses for recreational vehicles, it will be understood by those skilled in the art that the apparatus is not limited to this specific application. Various embodiments may be implemented with other types of hoses, including but not limited to water hoses, air hoses, chemical drainage hoses, and so on, and in a wide range of contexts such as industrial, agricultural, marine, or residential settings. The features and principles described are broadly applicable to any situation where hose management, containment, or drainage is desired, and modifications may be made without departing from the spirit and scope of the disclosure.

The storage apparatus may be constructed from a variety of materials selected based on the intended application, desired durability, and environmental conditions. As noted above, for typical RV sewer hose applications, lightweight and corrosion-resistant materials such as high-density polyethylene (HDPE), polypropylene, or ABS plastic are suitable due to their resistance to moisture, chemicals, and UV exposure. In more demanding industrial or marine environments, materials such as stainless steel or powder-coated aluminum may be preferred for their structural strength and enhanced resistance to corrosion and extreme temperatures. For agricultural or residential hose storage, weather-resistant composites, rubber-coated metals, or treated wood could be used to balance aesthetics with durability. The selection of materials can be tailored to meet specific performance needs while ensuring long-term functionality across diverse applications.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

The terms “approximately” and “substantially” are used to account for variations that may occur due to manufacturing tolerances, measurement inaccuracies, and other practical considerations in implementing the described technology. The term “approximately” refers to a value or range that is close to the stated value but allows for minor deviations, typically within ±10%, unless otherwise specified, that do not materially affect the function or purpose of the invention. Similarly, the term “substantially” is used to indicate that a particular feature, characteristic, or result is largely present or achieved, with allowable variations without deviating from the intended scope and function of the invention. These terms should be interpreted in a manner consistent with the understanding of a person skilled in the art.

Additionally, the various embodiments set forth herein are described in terms of exemplary block diagrams, flow charts, and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A sewer hose support system, comprising:
a box comprising a base and sidewalls defining an interior space, wherein the sidewalls comprise two short sidewalls and two long sidewalls;
a lid of a complementary geometry to the box such that the lid covers the interior space;
a pair of molded handles positioned on each short sidewall of the box, wherein each short sidewall of the box are laterally opposite from each other; and
a first trough integrated into the lid and a second trough integrated into the box, the first and second trough adapted to cooperate with a support bridge system to retain a sewer hose.

2. The sewer hose support system of claim 1, wherein the lid further comprises four raised corners, each raised corner further comprising an indentation.

3. The sewer hose support system of claim 1, wherein the support bridge system comprises a plurality of support bridges, wherein each support bridge is a different height such that when the plurality of support bridges are disposed in a particular order, the different heights of each support bridge define a continuous downward pitch.

4. The sewer hose support system of claim 3, wherein each support bridge of the support bridge system further comprises a support trough.

5. The sewer hose support system of claim 3, wherein each support bridge of the plurality of support bridges further comprises a set of four legs.

6. The sewer hose support system of claim 1, further comprising a locking tab, the locking tab comprising a top portion and a bottom portion, the top portion integrated into the lid and the bottom portion integrated into at least one handle of the pair of molded handles.

7. A system for storing a sewer hose and support bridges, comprising:
a box comprising a base and sidewalls defining an interior space;
a lid attachable to the box that encloses the interior space;
a first support bridge of a geometry to be nested within the box; and
a trough integrated into the box of a geometry to support the support bridge when nested within the box.

8. The system of claim 7, further comprising a handle integrated into the box.

9. The system of claim 7, wherein the lid further comprises four raised corners, each raised corner further comprising an indentation.

10. The system of claim 7, further comprising a second support bridge, wherein the second support bridge is a different height from the first support bridge, such that when the first and second support bridges are placed in a row, the first and second support bridges define a continuous downward pitch.

11. The system of claim 10, further comprising a third support bridge, wherein the third support bridge is a different height from the first and second support bridge, such that when the first, second, and third support bridges are placed in a row, the first, second, and third support bridges define the continuous downward pitch.

12. The system of claim 7, wherein the first support bridge further comprises a support trough.

13. The system of claim 7, wherein the lid further comprises a second trough.

14. A sewer hose storage apparatus, comprising:
a box comprising a base and sidewalls defining an interior space;
a lid attachable to the box that encloses the interior space;
a locking tab connected to the box and the lid to secure the lid to the box;
a molded handle formed into the box;
a first trough integrated into the box; and
a second trough integrated into the lid, wherein the first and second trough each are of a geometry to support a sewer hose in a predetermined position.

15. The sewer hose storage apparatus of claim 14, further comprising a support bridge system.

16. The sewer hose storage apparatus of claim 15, wherein the support bridge system comprises a plurality of support bridges.

17. The sewer hose storage apparatus of claim 16, wherein each support bridge of the plurality of support bridges further comprises a support trough that nests with the second trough when stored, and wherein each support bridge of the plurality of support bridges is a different height defining a continuous downward pitch when placed in a row.

18. The sewer hose storage apparatus of claim 16, wherein each support bridge of the plurality of support bridges further comprises a set of four legs.

19. The sewer hose storage apparatus of claim 15, wherein the molded handle further comprises a locking tab.

20. The sewer hose storage apparatus of claim 15, wherein the lid further comprises four raised corners, each raised corner further comprising an indentation.
